(19) United States
(12) Patent Application Publication
(10) Pub. No.: US 2025/0295542 A1
(43) Pub. Date: Sep. 25, 2025

(54) LONG BONE POSITIONING DEVICE

(71) Applicant: Jesua Law, Ripon, CA (US)

(72) Inventor: Jesua Law, Ripon, CA (US)

(21) Appl. No.: 19/076,785

(22) Filed: Mar. 11, 2025

Related U.S. Application Data
(60) Provisional application No. 63/567,264, filed on Mar. 19, 2024.

(51) Int. Cl. A61G 13/12; A61G 13/00

(52) U.S. Cl. CPC A61G 13/1245; A61G 13/0036

(57) ABSTRACT

A patient positioning device for use during the repair of a long bone procedure includes a crescent-shaped member detachably coupled to an elongated post member, a patient positioning instrument mounted in the track of the crescent-shaped member having an adjustable radial position toward the center of the crescent-shaped member, where the patient positioning instrument comprises at least one of a padded plunger, a bone pusher, and a bone hook. The device further includes a horizontally-oriented brace member mounted in the track of the elongated post member having an adjustable height position along the track, and the patient positioning instrument and the brace member being adapted to securely hold and support a patient's anatomy. The patient positioning device is coupled to a clamp for secure mounting to a surgical table.

### RELATED APPLICATION

The present application claims the benefit of U.S. Provisional Patent Application No. 63/567,264 filed on Mar. 19, 2024, the entirety of which is incorporated by reference.

### FIELD

The present disclosure relates to a device used during orthopedic procedures, and in particular a long bone positioning device used to position, support, and stabilize a patient's leg during the procedural repair of a long bone. (e.g., femur or tibia).

### BACKGROUND

The orthopedic surgical procedure to repair a long bone fracture involves realigning, positioning, supporting, and stabilizing the broken bone, e.g., the femur, the largest and longest bone in the human body. This type of fracture requires surgical intervention to promote proper healing and restore functionality. During the procedure, the fractured segments are realigned (reduced) to restore normal anatomy. Various fixation methods have been used to stabilize the fractured bone and facilitate proper healing. Common methods include intramedullary nailing, where a metal rod is inserted into the marrow cavity of the long bone to stabilize the fracture internally; installing plates and screws, where metal plates are affixed to the surface of the bone with screws to hold the fractured segments in place; and external fixation, where metal pins are inserted into the bone above and below the fracture, and an external frame is used to hold the bones in alignment. Antegrade and retrograde nailing are two different approaches to intramedullary nailing. These two approaches differ in the direction in which the nail is inserted into the long bone; like a femur. In antegrade femoral nailing, the surgical procedure involves inserting the intramedullary nail from the hip (proximal end) towards the knee (distal end). The nail is inserted into the femur through the greater trochanter. In retrograde femoral nailing, the intramedullary nail is inserted from the knee (distal end) towards the hip (proximal end). The nail is inserted into the femur through the intercondylar notch of the knee.

### BRIEF DESCRIPTION OF THE DRAWINGS

A better understanding of the claimed subject matter can be obtained when the following detailed description of the disclosed embodiments is considered in conjunction with the following figures.

FIGS. 1-4 are various views of an embodiment of the long bone positioning device according to the teachings of the present disclosure.

FIGS. 5A and 5B are two views of a modular embodiment of the long bone positioning device according to the teachings of the present disclosure.

FIG. 6 depicts yet another embodiment of the long bone positioning device having a modular crescent-shaped member (plunger not shown) coupled to a vertical post member that is in turn coupled to a modular offset neck member adapted to couple with a mounting device or base clamp according to the teachings of the present disclosure.

FIGS. 7 and 8 depict yet another embodiment of the long bone positioning device having a modular offset neck adapted to couple with a mounting device according to the teachings of the present disclosure.

FIGS. 9 and 10 depict yet another embodiment of the positioning device having a modular adjustable extension adapted to couple with existing surgical table clamps according to the teachings of the present disclosure.

FIG. 11 illustrates the forces on a femoral shaft fracture that causes mis-alignment of the shaft segments.

FIG. 12 illustrates conventional use of a bone hook and a bone pusher used to manually overpower the forces that cause misalignment of shaft segments in a femoral shaft fracture.

FIGS. 13 and 14 illustrate the use of one or two long bone positioning devices to properly position and support the long bone, ex femoral shaft, segments to enable proper alignment of the bony fragments.

### DETAILED DESCRIPTION

During any procedure to repair a long bone fracture, for example the femur, the largest, longest, and heaviest bone in the patient's body, the patient's thigh and leg often require manual manipulation, orientation, positioning, and support by the surgeon's assistant(s) to enable the surgeon to properly align the bone shaft and affix metal devices for reconstruction and fixation. A common make-shift way used in many operating rooms to position and prop up the patient's thigh/leg is to use a crutch with one end taped to the floor. The use of an unsterile crutch that is jerry-rigged to achieve this end is highly problematic. The crutch is not firmly secured in place, which may lead to unintended movement of the patient's thigh/leg. Because of the bulk and length of the crutch, it is difficult to manipulate equipment around it, such as X-ray machines. Also due to its length, it is easy for the surgeon and medical staff to accidentally nudge it out of place and change its position thereby losing the reduction of the fracture fragments out of alignment.

The present disclosure describes a plurality of embodiments of a long bone positioning device that may be securely affixed to the operating table and used to support the patient's thigh/leg during an orthopedic procedure such as a femoral shaft repair or other long bone procedure. The long bone positioning device is adjustable in multiple axes to accommodate variations in the patients' anatomy.

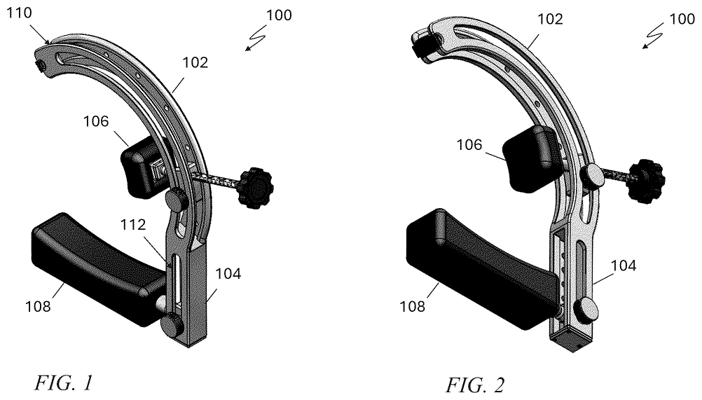

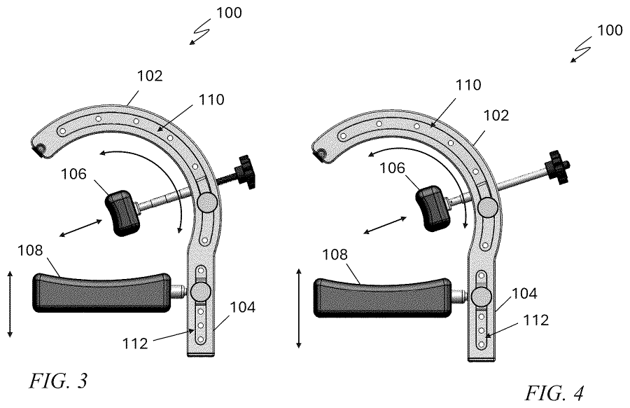

FIGS. 1 and 2 are two views of an embodiment of a long bone positioning device (with the femur depicted) 100 according to the teachings of the present disclosure. The long bone positioning device 100 includes a generally crescent-shaped member 102 coupled to a vertical post member 104, where the crescent-shaped member 102 accommodates an adjustable plunger 106 and the vertical post member 104 accommodates an adjustable horizontally-oriented brace member 108. The plunger 106 and/or brace member 108 may be made of radiolucent materials to allow for case of x-rays during the surgical procedure. The plunger 106 can be positioned and secured at any point along a crescent-shaped track or slot 110 formed in the crescent-shaped member 102. The plunger 106 can also be adjusted to vary the length of projection toward the center of the crescent-shaped member 102. As shown in FIGS. 3 and 4, the inward projection of the plunger 106 in the crescent-shaped member 102 may be variable using a threaded or slide mount, respectively. The elevation or height of the brace member 108 can also be adjustably varied along a linear track 112 formed in the vertical post member 104.

In operation, the long bone positioning device 100 shown in FIGS. 1-4 can be secured to the edge of the surgical table and used to securely support and position the patient's leg/thigh during a surgical procedure; femur bone depicted. The inward position and configuration of the plunger 106 along the crescent-shaped track 110 can be adjusted and secured, and the height of the horizontally oriented brace member 108 can be adjusted and secured at any point along the vertical track 112 in the vertical post member 104. Both the plunger 106 and brace member 108 can be padded to avoid bruising the patient's leg/thigh. If the positioning device 100 is to be used as a sterile holder, then the plunger 106 as well as the brace member 108 will need to be sterile. The patient's leg or thigh is held, supported, and stabilized by the use of the plunger 106 and the brace member 108, which is in turn securely affixed to a surgical table using a clamp (described below).

The long bone positioning device 100 shown in FIGS. 1-4 are intended to be used with an plunger member 106 for contacting the patient's skin in a “nonsterile” manner. The entirety of the apparatus 100 can be made to be used in a sterile fashion so that the surgeon can make adjustments intraoperatively. Also, the plungers 106 may be adapted to incorporate sterile instruments such as a “bone pusher” and “bone hook” that are intended to directly contact the patient's bone during the surgical procedure. As such, the sterile instruments incorporated as part of the long bone positioning device 100 serve as substitutes for the plunger.

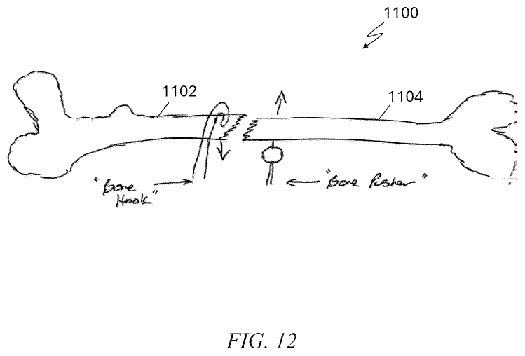

FIG. 11 illustrates the forces on a fracture in a femoral shaft 1100 that causes mis-alignment of the proximal and distal shaft segments 1102 and 1104, respectively. As shown, muscles and tendons attached to the proximal femoral shaft segment 1102 cause it to deform and be pulled out of alignment, and gravity causes the broken end of the distal shaft segment 1104 to sag. FIG. 12 shows a typical surgical situation where the surgeon is required to have an assistant manually hold the surgical instruments (bone hook and bone pusher) in place to position the fracture fragments 1102 and 1104 in alignment for fracture fixation. FIG. 12 illustrates the conventional use of a bone hook and a bone pusher on the femoral shaft segments 1102 and 1104 by an assistant to manually manipulate them directly to force the proper alignment of segments. The assistant in this role is required to, despite fatigue and tired muscles, hold the fracture fragments 1102 and 1104 in the proper position without movement for an extended length of time.

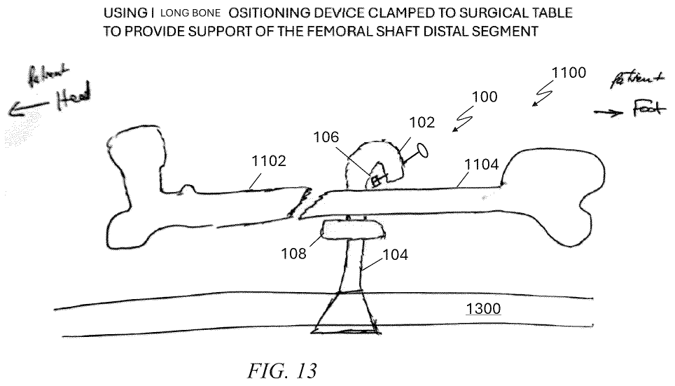

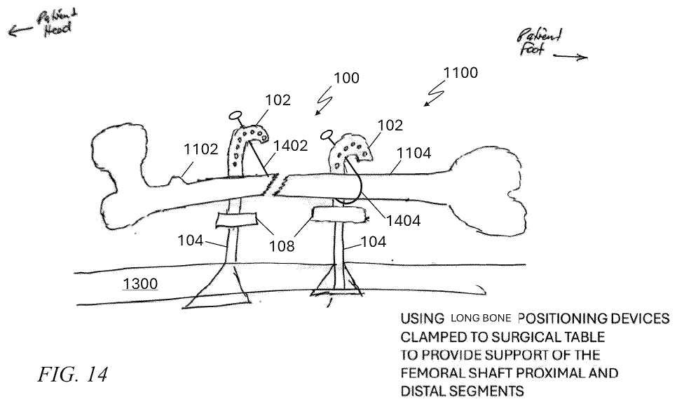

FIGS. 13 and 14 illustrate scenarios where the use of one or two long bone positioning devices 100 secured to a table 1300 and incorporate plungers 106 and/or bone pushers 1402 and/or bone hooks 1404 may be used to achieve proper position and support for the bone segments 1102 and 1104 to enable proper alignment and orientation of the shaft segments 1102 and 1104; femoral shaft depicted. The sterile application of a bone hook tool and/or a bone pusher tool mounted in in the crescent-shaped track 110 of the long bone positioning device 100 in place of the plunger 106, the proper position and alignment of the femoral shaft segments 1102 and 1104 may be achieved in a more reliable manner. Using the same adjustments, the length of extension of the bone hook 1404 and bone pusher 1402 and the height of the brace members 108 can be easily configured and adjusted to exert the proper amount of force in the proper direction on the bony segments to ensure proper positioning and alignment.

Using the long bone positioning device 100, both the need for the nonsterile crutch as well as a surgical assistant to hold and stabilize the long bone fragments in place during the procedure may be entirely eliminated. As can be expected, the use of an assistant to hold fracture reduction can be troublesome due to the assistant tiring in a lengthy procedure thereby losing fracture reduction.

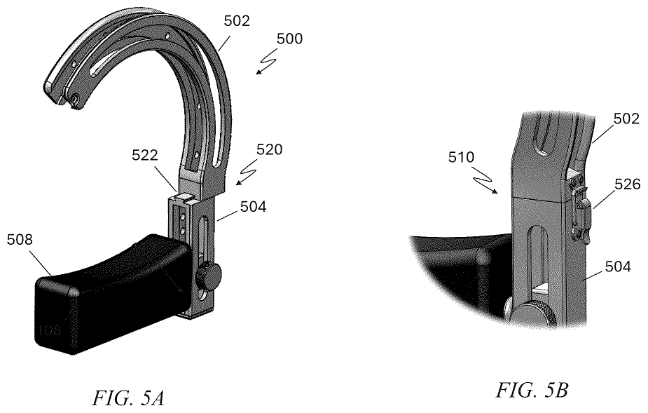

FIGS. 5A and 5B show a modular embodiment of the long bone positioning device 500 to enable the crescent-shaped member 502 to be easily swapped out with another crescent track member with different dimensions (e.g., radius) without removing the entire apparatus from the surgical table or repositioning of the patient's leg/thigh on the horizontal brace member 508. At the modular interface 520 of the crescent-shaped member 502 and vertical post member 504 is an alignment feature 522 to facilitate easily swapping of the crescent-shaped member 502 to different sizes and/or configurations. A locking clip 526 may be used to secure the modular interface of the two components 502 and 504 together.

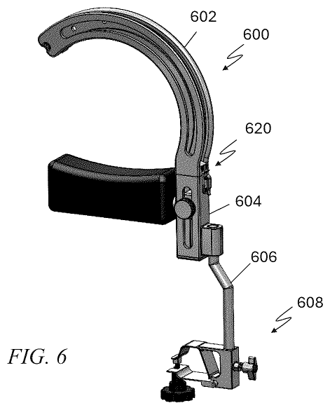

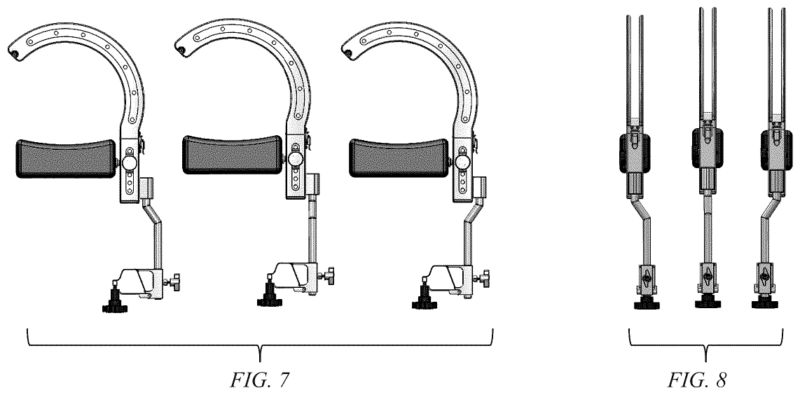

FIG. 6 depicts yet another embodiment of the long bone positioning device 600 having a modular crescent-shaped member 602 (plunger not shown) coupled to a vertical post member 604 that is in turn coupled to a modular offset neck member 606 adapted to couple with a mounting device or base clamp 608 according to the teachings of the present disclosure. FIGS. 7 and 8 depict embodiments of the modular offset neck and table adapter 606 of the long bone positioning device 600 according to the teachings of the present disclosure. The modular offset neck member 606 enables the long bone positioning device 600 to couple to different modular offset neck configurations to adapt to the needs of the surgeon to position and support patients of all sizes and accommodate all surgical site variations.

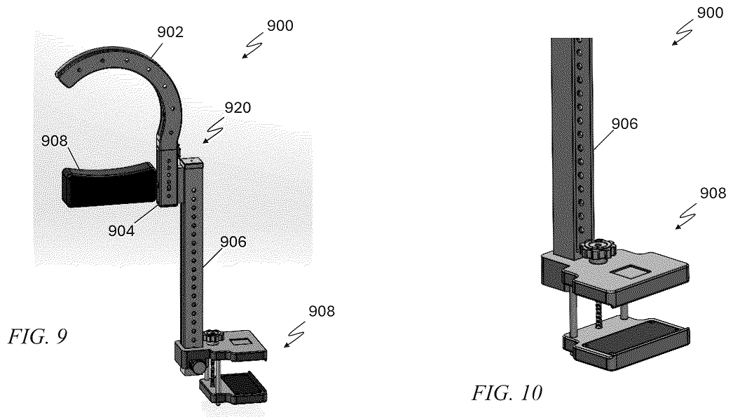

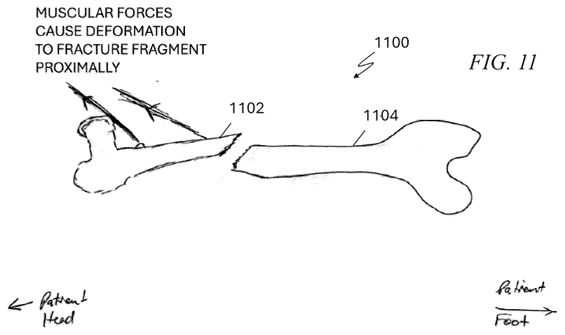

FIGS. 9 and 10 depict yet another embodiment of the long bone positioning device 900 having a modular crescent-shaped member 902 (plunger not shown) coupled to a vertical post member 904 that is in turn coupled to a modular adjustable extension member 906 adapted to couple with an existing surgical table clamp (e.g., a fracture table clamp) 908 according to the teachings of the present disclosure. The use of the modular adjustable extension member 906 enables additional variability in the adjustable height of the brace member 908. The modularity of the long bone positioning device 900 enable easy swapping of its components so that it may be easily adapted to accommodate variable patient anatomy and accept any existing or new surgical table clamps or fixtures.

It should be noted that the long bone positioning device may be available in a variety of sizes to accommodate the large variation in patient anatomical sizes and weights. The long bone positioning device may be manufactured to have various sizes (crescent track diameters and vertical post lengths) to accommodate patients of all sizes. The crescent track may also come in an “extended” arc to allow for additional plunger position options or obese patients. Additionally, more than one plunger, bone pusher, and/or bone hook may be incorporated into the crescent track of a single positioning device if needed to ensure patient bone segment proper positioning and alignment.

The features of the long bone positioning device described in the present disclosure which are believed to be novel are set forth below with particularity in the appended claims. However, modification, variations, and changes to the exemplary embodiments described above will be apparent to those skilled in the art, and the disclosure described herein thus encompasses such modification, variations, and changes and are not limited to the specific embodiments described herein.

What is claimed is:

1. A long bone positioning device comprising:
an upper crescent-shaped member coupled to a generally elongated vertical post member;
a plunger mounted in the generally crescent-shaped member having a padded end pointing inwardly toward a center of the crescent-shaped member, the plunger having adjustable radial positioning toward the center of the crescent-shaped member;
a generally horizontally-oriented padded brace member mounted in the generally elongated vertical post member, the brace member having adjustable height positioning relative to the position of the padded end of the plunger; and
a mounting interface to a clamp adapted for secure affixing to a surgical table.

2. The long bone positioning device of claim 1, wherein the mounting interface comprises a modular bracket.

3. The long bone positioning device of claim 1, wherein the mounting interface comprises a modular bracket and a modular offset neck member.

4. The long bone positioning device of claim 1, wherein the mounting interface comprises a modular adjustable extension member.

5. The long bone positioning device of claim 1, wherein the upper crescent-shaped member and generally elongated vertical post member are detachably coupled with an alignment interface and a locking clip.

6. The long bone positioning device of claim 5, wherein the crescent-shaped member comprises modular crescent-shaped members of variable radius.

7. The long bone positioning device of claim 1, wherein the crescent-shaped member comprises a crescent-shaped track adapted to accommodate and secure the plunger along the length of the track.

8. The long bone positioning device of claim 1, wherein the vertical post member comprises a generally linear track adapted to accommodate and secure the brace member along the length of the track.

9. A patient positioning device comprising:
a crescent-shaped member coupled to a generally elongated post member;
a patient positioning instrument mounted in the crescent-shaped member having an adjustable radial position toward the center of the crescent-shaped member;
a horizontally-oriented brace member mounted in the elongated post member having an adjustable height position along the post member;
the patient positioning instrument and the brace member being adapted to securely hold and support a patient's anatomy; and
the generally elongated post member being mountable to a clamp adapted for secure coupling to a surgical table.

10. The patient positioning device of claim 9, wherein the patient positioning instrument comprises one of a padded plunger, a bone pusher, and a bone hook.

11. The patient positioning device of claim 9, wherein the patient positioning instrument has an adjustable position along the length of the crescent-shaped member.

12. The patient positioning device of claim 9, wherein the crescent-shaped member and the generally elongated post member are detachably coupled.

13. The patient positioning device of claim 9, wherein the elongated post member is coupled to a modular offset neck member.

14. The patient positioning device of claim 9, wherein the elongated post member is coupled to a modular adjustable extension member.

15. The patient positioning device of claim 9, wherein the crescent-shaped member and generally elongated post member are detachably coupled with an alignment interface and a locking clip.

16. The patient positioning device of claim 9, wherein the crescent-shaped member comprises modular crescent-shaped members of variable radius that may be easily swapped out to accommodate variable patient anatomy.

17. A patient positioning device for use during a surgical procedure, comprising:
a crescent-shaped member detachably coupled to an elongated post member, both the crescent-shaped member and the elongated post member each has a track along its length;
a patient positioning instrument mounted in the track of the crescent-shaped member having an adjustable radial position toward the center of the crescent-shaped member;
the patient positioning instrument comprises at least one of a padded plunger, a bone pusher, and a bone hook;
a horizontally-oriented brace member mounted in the track of the elongated post member having an adjustable height position along the track;
the patient positioning instrument and the brace member being adapted to securely hold and support a patient's anatomy; and
the generally elongated post member being mountable to a clamp adapted for secure coupling to a surgical table.

18. The patient positioning device of claim 17, wherein the crescent-shaped member comprises modular crescent-shaped members of variable radius that may be easily swapped out to accommodate variable patient anatomy.

19. The patient positioning device of claim 17, wherein the elongated post member is coupled to a modular offset neck member.

20. The patient positioning device of claim 17, wherein the elongated post member is coupled to a modular adjustable extension member.
